(19) United States
(12) Patent Application Publication
(10) Pub. No.: US 2011/0273036 A1
(43) Pub. Date: Nov. 10, 2011

(54) POWER TOOL HAVING A DIRECT CURRENT MOTOR AND POWER ELECTRONICS

(76) Inventor: Dietmar Saur, Gomaringen (DE)

(21) Appl. No.: 12/998,795

(22) PCT Filed: Nov. 2, 2009
(86) PCT No.: PCT/EP2009/064437

§ 371 Date: Jul. 28, 2011

(30) Foreign Application Priority Data
Dec. 5, 2008 (DE) 10 2008 044 390.5

(51) Int. Cl. H02K 7/14

(52) U.S. Cl. 310/50

(57) ABSTRACT

A power tool has a direct current motor and power electronics including power components and logic components for operating the direct current motor. The power components are situated on the direct current motor as a power unit.

### BACKGROUND OF THE INVENTION

1. Field of the Invention

The present invention relates to a power tool having a direct current motor and power electronics having power and logic components for operating the direct current motor.

2. Description of Related Art

Power tools of the kind named at the outset are known. If these are operated using a direct current motor, special switching electronics are required for operating this direct current motor. Pulse width modulation technique is used for this purpose, as a rule. Using this, the direct current motor is able to be accurately controlled in a simple manner. This requires power electronics having power components which switch an electrical connection between the direct current motor and an energy source, and logic components which appropriately control the line components for operating the direct current motor. The logic components receive signals from an operating switch of the power tool, in this context, and, as a function of the signals received, they control the power components, also known as power switch. Such operating switches are frequently produced as a switch module that is insertable into the power tool, which includes the power electronics and is connected by cables to the direct current motor and the energy source. In another embodiment, the components of the power electronics are mounted on a circuit carrier, such as a printed circuit board, and from there, are again connected using cable connections to the direct current motor and the voltage source. Power semiconductors, transistors and/or diodes are used as power components, as a rule.

### BRIEF DESCRIPTION OF THE INVENTION

It is provided, according to the present invention, that the power components are situated as a power unit on the direct current motor. It is also provided that the power components of the power electronics form a separate unit, and are thus essentially separated from the logic components. The terms unit and separation should be understood spatially. Between the components, there naturally has to remain an (electrical) operating connection, so that they are able to function as power electronics. However, the power components are situated as a power unit of the power electronics on the direct current motor. The advantageous development and situation of the power unit permits, especially, short electrical connecting lines of the power components and the power unit of the power electronics to the direct current motor, which leads to a current flow that is optimized as to resistance. Consequently, overall a power loss-optimized system is formed in the power tool. Especially in the case of high currents, which flow between the power components or the power unit and the direct current motor, this leads to higher power of the power tool. The electrical connection of the power unit to the logic components, which are expediently provided as a logic unit, is advantageously implemented using thin connections/cables, as seen in cross section. If the logic unit is at the operating switch, and is thus situated at a distance from the direct current motor, it is not necessary, based on the connection used only for signal transmission, to guide wide/thick cables from the operating switch to the direct current motor. Thin connections are sufficient for transmitting the signals of the logic unit, by which the power components or the power unit is controlled. These have the advantage that they are more cost-effective, for one thing, and for another, that, based on their greater flexibility, they are easier to install than wider cables.

The power unit is advantageously developed as a power module. This means that the power unit can be handled as a component during assembly of the power tool, and that, in an appropriate system, is able to be exchanged in a simple manner and/or is able to be applied to different direct current motors. The power module, in this instance, preferably has a housing used for easier handling as well as to protect the power unit.

The power module is preferably fastened to the direct current motor using a first plug connection. The power module and the direct current motor expediently have plug connector elements for this, such as a plug and a female connector. The plug connection may also be developed to be clamping, so that the power module is held to the direct current motor essentially in a force-locking manner. In one further specific embodiment, the plug connection has, additionally or alternatively, one or more snapping means, such as an elastically displaceable locking hook, which latches in a depression or behind an elevation, so that a form-locking securing is created, which prevents the unintentional release of the power module from the direct current motor in a simple manner. Alternatively or in addition, soldering the power module to the direct current motor and/or fastening by using press fitting or using at least one insulation displacement termination are conceivable.

In an especially preferred way, the first plug connection is developed to be electrically conductive. This means that the power module, by simply plugging together with the direct current motor, is both fixed to it and, beyond that, is also electrically connected to it. This simplifies the assembly, and particularly lowers the wiring expenditure, and improves or optimizes the current flow between the power module and the direct current motor.

According to one refinement of the present invention, the power module is connected to a rechargeable energy store, particularly a storage battery, using a second plug connection. This second plug connection does not necessarily represent a direct connection from the power module to the energy store, but may also be a connecting piece of a contact bridge that is able to be plugged together with the power module and the energy store. Thus, an area of the contact bridge is advantageously designed so that the energy store is exchangeable in a simple manner. The plug connection between the power module and the contact bridge is expediently developed, in this case, in such a way that there is a firm union which ensures a durable electrical connection. This creates an electric cable-free connection, that is particularly resistance optimized/loss optimized, from the energy store to the direct current motor, or rather from the energy source to the energy user.

According to one advantageous refinement of the present invention, the power module is situated in a cooling air intake region of the direct current motor. The simplest method of cooling electric machines, such as the direct current motor, in operation is by air cooling. During operation, the direct current motor, in this instance, generates an air flow by the rotation of the rotor and possibly of a fan impeller connected to it/driven by it, which goes through the direct current motor. For this purpose, the direct current motor expediently has openings in the housing at the appropriate places, through which the environmental air/cooling air is drawn in. Because of the situation of the power module in the region of such a cooling air intake region, this achieves that the power module gives off power losses in the form of heat to the air current drawing past it. In comparison to known power tools, a greater cooling performance is thus attained, with the result that comparatively low power components, especially smaller power semiconductors, may be used which, on the one hand has advantages with respect to installation space and, on the other hand, with respect to production costs.

Furthermore, it is provided that the power module have at least one cooling element, particularly one or more cooling ribs. The power module expediently encloses the power components, essentially with the housing, the power components advantageously lying against the housing, which expediently has a high heat conductivity, so that the heat generated in the power components is easily dissipated into the housing. The cooling ribs expediently form a part of the housing, or are mounted on it for optimized heat conduction, so that the heat of the power components is able to be removed in optimal fashion to the cooling ribs via the housing of the power module. In this context, the cooling ribs advantageously lie in the cooling air intake area of the direct current motor, where they give off the heat dissipated by the power components directly to the cooling air current. In an especially preferred manner, the cooling element is in direct touch contact to the power components, in order to optimize the heat dissipation.

Finally, it is provided that the power tool is a hand power tool.

The power electronics according to the present invention are distinguished by the power components being developed as a power unit that is able to be positioned on the direct current motor. As was described above, this permits electrical connections from the power components to the direct current motor that are optimized as to resistance and power loss.

The power unit preferably developed as a power module expediently has an electrically conductive plug connection for the direct current motor. Using this electrically conductive plug connection, the power module is able to be fastened to the direct current motor in a simple manner, at the same time an electrical connection being produced. The plug connection is preferably developed in such a way that the power module is able to be plugged onto the direct current motor and the connecting contacts of the direct current motor.

Furthermore, it is provided that the power module have an electrically conductive plug connection for a rechargeable energy store, especially for a storage battery. Thus, a wireless electrical connection from the direct current motor to the energy store is produced, whereby assembly is made easier and the energy losses are reduced.

Finally, it is provided that the power module have at least one cooling element, particularly one or more cooling ribs. Using the cooling elements, or rather the cooling ribs, the heat loss of the power components, which expediently are power semiconductors, is particularly favorably carried off into the environment.

### BRIEF DESCRIPTION OF THE DRAWINGS

FIG. 1 shows a schematic representation of the advantageous power tool.

FIG. 2 shows a power module having a direct current motor in a perspective representation.

### DETAILED DESCRIPTION OF THE INVENTION

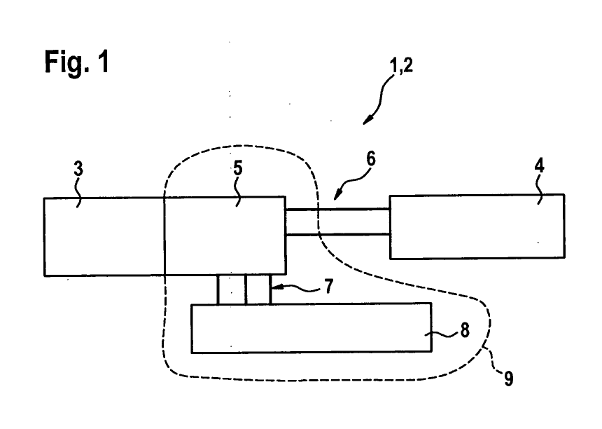

In a schematic representation, FIG. 1 shows an exemplary embodiment of an advantageous power tool 1, which is developed as a manually operated power tool 2. Manually operated power tool 2 has a direct current motor 3 which is supplied with energy by a rechargeable energy store 4. Energy store 4 is preferably a storage battery, especially an exchangeable storage battery. A power unit 5 is situated on direct current motor 3, which includes one or more power components, particularly power switches, such as transistors, diodes, semiconductors or the like. The necessary electrical connection between direct current motor 3 and energy store 4 is able to be produced using the power components. Power unit 5 is connected to energy store 4, for this purpose, using an electrical connection 6. Furthermore, power unit 5 has an electrical connection 7 to a logic unit 8, which includes one or more logic components that are used to control the power components. Logic unit 8 and power unit 5 together form power electronics 9 for operating direct current motor 3.

The advantageous subdivision and separation of power electronics 9 into a spatially autonomous power unit 5 and into a spatially autonomous logic unit 8 permits the spatially separated positioning of the power components on direct current motor 3. Based on the integration of power unit 5 on direct current motor 3 and the short paths conditioned thereby, the high currents, that flow between power unit 5 and direct current motor 3, experience only slight losses, so that, at constant power or capacitance of energy store 4, a greater power of direct current motor 3 is achieved. For the electrical connection of power unit 5 to direct current motor 3, advantageously lines are provided having a large cross section. Because of the direct spatial assignment, the shortest possible connection is thus ensured, and the losses (such as ohmic losses) are minimized. Since only signals, that is, only small currents, are transmitted between logic unit 8 and power unit 5, electrical connection 7 may be implemented using cables having a very small diameter (thin connections).

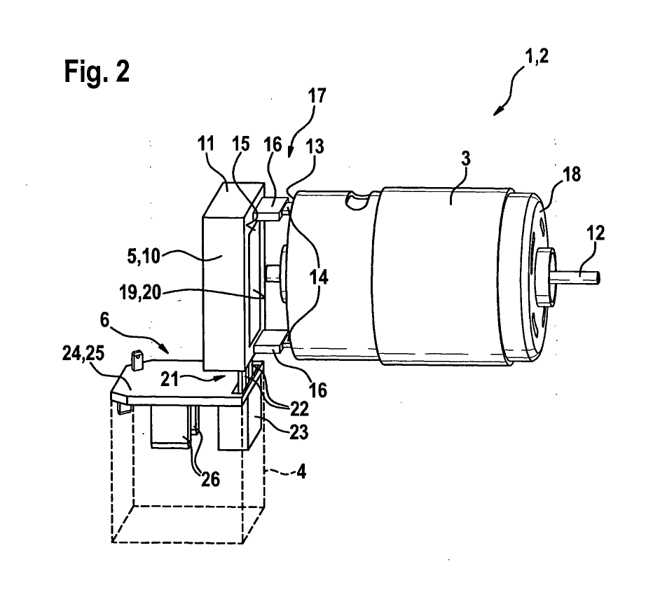

The thin cables permit simple handling during assembly, particularly because of their great flexibility. Electrical connection 6 may also be executed as a cable connection, but in that case, larger cross sections are required. One preferred embodiment of electrical connection 6 will be explained in FIG. 2.

FIG. 2 shows an additional exemplary embodiment of advantageous power tool 1 or manually operated power tool 2, in a perspective representation, in this case, too, only components being shown that are essential to the present invention. Elements known from FIG. 1 are provided with the same reference numerals, so that items already described will not be repeated.

Power unit 5 is developed as power module 10, in the present exemplary embodiment. For this purpose, it has an essentially box-shaped housing 11, in which the power components are situated. Power module 10 is situated in the extension of a drive shaft 12 of direct current motor 3, in this context. At its end face 13, that is opposite to power module 10, direct current motor 3 has diametrically situated contact plugs 14, that is, electrically conductive plug elements which stand away perpendicularly from end face 13. Correspondingly, power module 10, at its surface 15 of housing 11, that faces direct current motor 3, has two contact plug receptacles 16, which are developed to stand away from surface 15, so that they act as spacers at the same time. Contact plug receptacles 16 and contact plugs 14 together form a first plug connection 17. Power module 10, in the present case, is plugged onto direct current motor 3 in a simple manner, using plug connection 17, and is thus situated on it. Since contact plugs 14, and expediently also contact plug receptacles 16 are developed at least in some areas to be electrically conductive, the electrical contact between direct current motor 3 and power unit 5 is produced via plug connection 17 at the same time. Consequently, a wireless connection is made possible of the power components/power switches to direct current motor 3. For one thing, this simplifies the assembly and, for another, it reduces losses in the current lines. The connection of logic unit 8, that is not shown here, expediently takes place as described above.

On its end face 13, direct current motor 3 also has openings that are not recognizable here, through which the air for cooling is sucked into the inside of direct current motor 3 during its operation, and this air flows out again through openings developed in end face 18 that lies opposite to end face 13. Power module 10 or power unit 5 is preferably situated in the intake region, or stated more exactly, in a cooling air intake region of direct current motor 3. This has the result that power module 10, in the operation of direct current motor 3, is located in a cooling air current to which power module 10 gives off the heat (loss) created in power unit 5. Power module 10 also has a cooling element 19 situated on surface 15, which is advantageously developed as cooling ribs 20, cooling ribs 20 being expediently in operating contact with the power components of power unit 5, so that, in a simple and favorable manner, the heat is given off via cooling ribs 20 to the cooling air flow of direct current motor 3. This system makes possible a good and rapid dissipation of the (heat) losses, particularly in the case of applications which frequently change between idling and locking operation. Because of the system, the cooling for power unit 5 is further increased so that, as a whole, smaller and more cost-effective power components are able to be used, whereby advantages come about with respect to the design size as well as the production costs of power tool 1 and power electronics 9. Alternatively to plug connection 17 described above, it is also conceivable that power module 10 could be soldered, clamped and/or pressed onto direct current motor 3, in order to produce both the mechanical and the electrical contact.

Electrical connection 6 from power module 10 to energy store 4 (storage battery) is also formed by a plug connection 21, in the present exemplary embodiment. For this, power module 10 has two contact plugs 22, which stand away from power module 10 or housing 11, and are plugged into a contact plug receptacle 23 of a contact bridge 24. Contact bridge 24 has a carrier element 25 that is electrically nonconductive, on which electrically conductive contact traces are situated. These lead essentially from contact plug receptacle 23, in which the electrical contact to power module 10 is produced, to contact plugs 26, which cooperate with energy store 4, that is indicated only by broken lines, in this case. Thus, contact bridge 24 represents an intermediary piece, that is plugged between power module 10 and energy store 4. Contact bridge 24 is expediently developed in such a way that the electrical connection using contact plugs 26 to energy store 4 is designed so that energy store 4 may be simply exchanged, whereas the electrical connection to power module 10 is developed so that a durable, secure electrical contact is ensured. Consequently, all in all electrical connection 6 from energy store 4 to direct current motor 3 is developed to be wireless, whereby a system comes about that is optimized as to power loss and has a current flow that is optimized as to resistance. In addition, compared to the related art, the system has a reduced number of contact locations, and with that, of transition resistances. Because of the plug connections, (particularly 17 and 21) an especially simple and cost-effective assembly of manually operated power tool 2 is made possible.

Because of the advantageous separation of the power unit and the logic unit of power electronics 9, it is possible to equip different products, using power unit 5 and using power module 10, such as different direct current motors, and to implement the different (control) variants via logic unit 8, such as, for instance, an optional work place illumination, an optional indication of the capacitance of the energy store or optional recording of the motor temperature.

1-12. (canceled)

13. A power tool comprising:
a direct current motor; and
power electronics including power components and logic components for operating the direct current motor, wherein the power components are situated on the direct current motor as a power unit.

14. The power tool as recited in claim 13, wherein the power unit is configured as a power module.

15. The power tool as recited in claim 14, wherein the power module is fastened to the direct current motor using a first plug connection.

16. The power tool as recited in claim 15, wherein the first plug connection is configured to be electrically conductive.

17. The power tool as recited in claim 16, wherein the power module is connected to a rechargeable energy store using a second electrically conductive plug connection.

18. The power tool as recited in claim 17, wherein the power module is situated in a cooling-air intake region of the direct current motor.

19. The power tool as recited in claim 17, wherein the power module has at least one cooling element.

20. The power tool as recited in claim 17, wherein the power tool is a manually operated power tool.

21. Power electronics for operating a direct current motor of a power tool, comprising:
logic components for controlling the direct current motor; and
power components configured as a power unit adapted to be positioned on the direct current motor.

22. The power electronics as recited in claim 21, wherein the power unit is configured as a power module and has an electrically conductive plug connection for the direct current motor.

23. The power electronics as recited in claim 22, wherein the power module has an electrically conductive plug connection for a rechargeable energy store.

24. The power electronics as recited in claim 23, wherein the power module has at least one cooling element.
